(19) United States
(12) Patent Application Publication
(10) Pub. No.: US 2025/0287469 A1
(43) Pub. Date: Sep. 11, 2025

(54) COVER, ESPECIALLY FOR INFRARED HEATER, AND CENTRIFUGE

(71) Applicant: Me-Sep Sp. z o.o., Krakow (PL)

(72) Inventors: Szymon Dutczak, Kraków (PL); Krzysztof Trzaskus, Kraków (PL)

(21) Appl. No.: 19/072,990

(22) Filed: Mar. 6, 2025

(30) Foreign Application Priority Data
Mar. 6, 2024 (EP) 24161896.6

(51) Int. Cl. H05B 3/00; B04B 15/02

(52) U.S. Cl. CPC H05B 3/0033; B04B 15/02

(57) ABSTRACT

The invention concerns shields, in particular for an infrared radiator and a centrifuge comprising a seat for accommodating an element for centrifugation and infrared radiators along with shields for infrared radiators.

A shield, in particular for an infrared radiator, comprising at least one window permeable for infrared radiation, preferably within the range of 1-150 μm, characterized in that it comprises fixing means configured for easy dismounting.

A centrifuge comprising a seat for accommodating an element for centrifugation and infrared radiators, characterized in that between the infrared radiator and the centrifugation element a shield as described above is provided.

### FIELD OF THE INVENTION

The invention concerns shields, in particular shields for an infrared radiator, and a centrifuge comprising a space for positioning an element for centrifugation and infrared radiators along with shields for infrared radiators.

### PRIOR ART

Document EP 1612540 B1 discloses a micro-mechanic infrared radiation source comprising a heating structure to generate infrared radiation, and a filtering means, wherein radiation exiting the infrared radiation source passes through said filtering means. One of the filtering means is a cover. The cover constitutes a first layer, while a second layer is comprised of a coating applied onto the cover. The cover is made of a material such as silicon, germanium or glass which is permeable for the desired range of wavelengths but it is not permeable for other wavelength ranges. The cover is coated with a filtering layer which is also permeable for the wavelength range considered but it has a reverse transmission characteristics relative to the cover material.

Centrifuges are intended for centrifugal flooding of capillary fibres into filtration modules with the use of resins such as epoxy, polyurethanes or silicones. Before the centrifuge is turned on, the module is mounted to the rotor along with an adhesive dispenser. With the rotor with modules mounted, the cover of the centrifuge is closed, the rotor starts to spin and the flooding chamber becomes heated up to the process temperature. Then flooding process starts. When the process parameters are reached, the resin is fed to the module housing via a central opening in the centrifuge cover. Due to the centrifugal forces the liquid resin flows (is spin off) to the outer ends of the adhesive dispenser where by means of a tubing it is transported to the module housing via pipes (e.g., the ones for the filtrate), and then to the ends of the flooded modules where it fills the spaces between the fibres. Upon curing of the resin the rotation is stopped and the modules may be removed from the flooding chamber.

During spinning the applied heat allows to obtain optimum process temperature. The chamber, along with the filtration modules prepared for flooding, is heated by, inter alia, blowing hot air or by infrared radiation.

The use of heating by infrared radiators causes that they are directly exposed to mechanical damage and surface contamination in the case of malfunction of the rotor and/or adhesive distribution system. Infrared radiators are arranged around the element being spin. During the centrifugal flooding process sometimes depressurization of the adhesive distribution system and/or moulds that close the ends of the filtration module occurs. This causes scattering of the liquid adhesive over the entire chamber of the centrifuge. The adhesive, being in most cases a resin, when arrives onto the surface of IR radiators, where the temperature of the radiator surface reaches about 750° C., starts thermal decomposition and produces smoke. The generated smoke may be toxic if epoxy resins are used. The surface of the chamber of the centrifuge along with the rotor may be covered with an antiadhesive coating in order to enable cleaning thereof, but the surface of the infrared radiator cannot be protected this way.

In the prior art, shields for infrared radiators used in centrifuges are not known.

### SUBJECT-MATTER OF THE INVENTION

It is the object of this solution to provide shields, that can be easily cleaned, for infrared radiators to ensure proper operation of the radiator while providing adequate protection thereof.

The invention provides a shield, in particular for an infrared radiator, comprising at least one window permeable for infrared radiation, preferably within the range of 1-15 μm, characterized in that it comprises fixing means.

Preferably, the at least one window is made of germanium, zinc selenide, sodium chloride, potassium bromide, zinc sulphide or silicon.

In one embodiment, the window is made of silicon monocrystal, preferably of a thickness of 50 μm-5 mm.

In one preferable embodiment, the fixing means is at least one fixing opening in the window.

The fixing means is a frame.

Preferably, the frame has a shape of a circle, square, rectangle, polygon, triangle or trapezoid.

In one preferable embodiment, the frame is made of aluminium, Teflon-coated aluminium, steel, stainless steel, metals and non-ferrous alloys or thermally stable polymers.

In one embodiment, the frame has at least one opening configured for insertion of immobilizing elements.

Preferably, the frame comprises at least one snap fastener.

The window is secured to the frame by means of screws, snap fasteners, magnets, riveting, spot welding, spot soldering or heat resistant adhesive.

A second aspect of the invention is a centrifuge comprising a seat for accommodating an element for centrifugation and infrared radiators, characterized in that between the infrared radiator and the element for centrifugation a window or shield is provided.

Preferably, the distance of the shield to the infrared radiator is 10 mm-200 mm.

In one embodiment, the shield is secured to the inner surface of the centrifuge.

In one preferable embodiment, the inner surface of the centrifuge comprises means for securing the shield, preferably in a form of a snap fastener, snap fastener seat, openings, threaded openings or magnets.

Preferably, the shield is screwed to the inner surface of the centrifuge, preferably the mounting screw extends through an opening in the frame and it is screwed to the wall of the chamber of the centrifuge.

### BENEFICIAL EFFECTS OF THE INVENTION

The subject invention provides comprehensive protection for infrared radiators in the case of malfunction of the rotor or adhesive distribution system. The adhesive then is not deposited on the heater but on the much cooler shield. The shield according to the invention can be easily dismounted for cleaning its soiled surface. An advantageous effect of the shield is infrared radiation transmission and this ensures stable operation of the infrared radiator. The shield is chemically and mechanically stable under conditions of continuous operation including high temperature.

### BRIEF DESCRIPTION OF THE DRAWINGS

The invention will be presented below in a preferable embodiment with reference to the enclosed drawings where:

FIG. 1—shows a frame with a window,

FIGS. 2 and 3—show an unshielded infrared radiator in a centrifuge,

FIG. 4—shows a shielded infrared radiator covered with a shield according to one embodiment of the invention.

### DETAILED SPECIFICATION OF EMBODIMENTS OF THE INVENTION

With reference to the enclosed drawings, technical aspects of the shield being object of this invention will be elucidated.

The subject-matter of the invention is a shield comprising at least one window 1 that transmits infrared radiation, said shield comprising fixing means configured for easy dismounting. For practical reasons, the means will be most likely an additional element such as a frame 2, but it cannot be excluded that such fixing means will be a mounting opening or several mounting openings arranged directly in the window 1. In such a case the shield may be applied onto pins or screwed, with the use of these openings, to the inner surface of the centrifuge.

The shield shown in FIG. 1 comprises at least one window 1 which is permeable for infrared radiation, preferably within the range of 1-15 μm, and comprises fixing means configured for easy dismounting, in this example having a form of four openings 4 in a frame 2. It should be noted that the indicated range of radiation, i.e., 1-15 μm, is the most preferable one, nevertheless due to material restrictions it should be understood that this should be construed that a possibly broad range of infrared radiation transmittance within such a range is sufficient for implementation of the invention.

In an embodiment, the window 1 is made of silicon. High temperature radiators 3 emit infrared radiation. The material used for the shields should transmit infrared radiation, preferably at 100%, should not heat up and should be mechanically stable. Such a material is, for example, silicon which is permeable for radiation substantially within the range of about 2-10 μm. There occurs a slight absorption of radiation, but it is still so small that the shield may operate under preset conditions. A person skilled in the art, in order to implement the invention, will be aware that other materials are possible which have the same required properties. Such materials are, for example, germanium, zinc selenide, sodium chloride, potassium bromide or zinc sulphide.

In another embodiment, window 1 is made of silicon wafers, i.e. silicon monocrystal. The window 1 has a thickness within the range of 50 μm-5 mm. This solution is advantageous due to silicon wafers availability in standard sizes and thicknesses.

In one embodiment, as shown in FIG. 1, the fixing means is a frame 2 which has a trapezoid shape. In other embodiments, it is possible to use other geometric shapes, such as a rectangle, square, circle, polygon or triangle, that enable easy dismounting of the frame 2 and thus the use of suitable fixing means which may have some other form than the openings 4 shown—these may be magnets, snap fasteners, pins, and a person skilled in the art will know how such shield should be fixed. The shape of the frame 2 is determined by the shape and construction of the infrared radiator 3.

Selection of the suitable mounting method depends on the shape of the frame 2, its size and the dimensions of the centrifuge to which shields are to be fixed. A centrifuge of a small size may preclude assembly by means of screwdrivers or other tools sue to their size, while press fitting or snap fasteners may result an optimum solution.

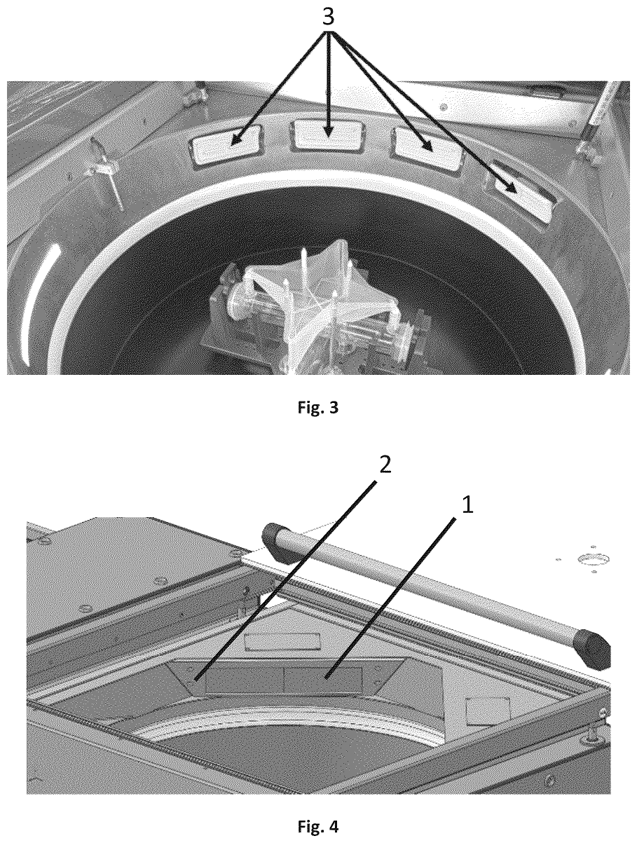

In this embodiment, the frame 2 is made of Teflon-coated aluminium. Material from which the frame 2 is made has to be thermally stable and prevent resin adhesion in the case of splashing during flooding of the frame 2. A person skilled in the art, in order to implement the invention, will be aware that also other thermally resistant materials may be used. Such material is, for example aluminium, steel, stainless steel, metals and non-ferrous alloys and/or thermally stable polymers. Thermally stable polymers may be Teflon or PEEK, PBI, PAI, PEK, PI, LCP or PTFE. In this embodiment, the window 1 is fixed to the frame 2 with the use of screws, snap fasteners, magnets, riveting, spot welding, spot soldering and/or heat resistant adhesive. Fixing with a heat-resistant adhesive, welding and soldering is an option for permanent fixing and constitutes and alternative embodiment of the invention. Such mounting is to provide stable position of the window 1 in the frame. FIG. 3 discloses a hollow space in the inner surface of the centrifuge, corresponding to the shape of the frame 2. User will easily fit the frame 2 into the space selected in this manner to mount it. FIG. 4 shows the frame 2 fixed to the inner surface of the rotor by means of four screw openings.

In this embodiment, the window 1 is made of at least two elements that transmit infrared radiation, shown in FIG. 1. The use of single elements that transmit infrared radiation, in order to obtain a larger surface area of the window 1, makes it possible to maintain mechanical stability of the window 1 and prevents possible damage or cracking during operation. Additionally, it is possible to use smaller pieces of e.g. silicon which are easier to obtain than bigger pieces. The shield may be implemented so that several smaller windows 1 are seated in one frame, such as in FIG. 1, where in one frame there are two windows 1, but also one shield may be made of several windows connected to each other solely by means of fixing screws.

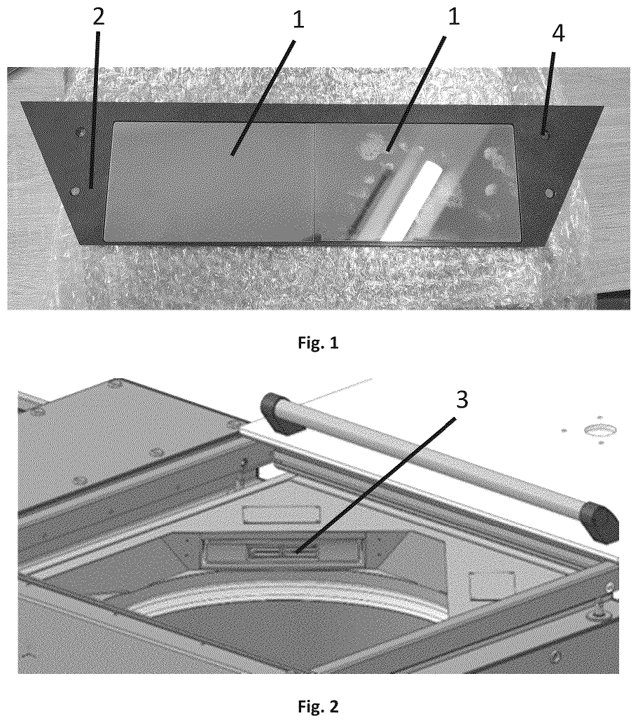

The subject application discloses a second aspect of the invention being a centrifuge comprising a seat to accommodate an element for centrifugation and infrared radiators 3. Between the infrared radiator 3 and the element for centrifugations, a shield as described earlier is arranged, or a window 1 alone. An implementation of the invention is possible wherein the window 1 alone is fixed directly to the inner surface of the centrifuge, i.e. it is slid-in into suitable grooves or guides, and this solution is not preferable, since most frequently such windows 1 are fragile and sharp and therefore difficult to be manipulated without causing damage or hurting the operator. FIG. 2 shows the positioning of infrared 3 radiators on the inner surface of the centrifuge around the element for centrifugation. The present centrifuge comprises conventional casting centrifuges, preferably for centrifugal flooding. The use of the shield prevents possible damage to the infrared radiator 3 and ensures easy dismounting and cleaning thereof in the case of unsealing in the adhesive distribution system, which unsealing without the shields would result in spreading the adhesive over the entire inner surface of the centrifuge, including over the infrared radiators. The user, upon opening of the centrifuge, dismounts the shield and then attaches it again without any problem.

Centrifuge may comprise at least one infrared radiator 3 and each one of them will require a separate shield to be mounted. For practical reasons, the distance of the shield to the infrared radiator 3 is 10 mm-200 mm. The inner surface of the shield comprises means for fixing the shield to cooperate with the shield—the means may be openings, threaded openings, snap fasteners or snap fastener seats. In one embodiment, as shown in FIG. 4, the shield is secured to the inner surface of the centrifuge by means of screws which extend through the openings 4.

1. A shield, in particular for an infrared radiator, comprising at least one window (1) permeable for infrared radiation, preferably within the range of 1-15 μm, characterized in that it comprises fixing means.

2. The shield according to claim 1, characterized in that at least one window (1) is made of germanium, zinc selenide, sodium chloride, potassium bromide, zinc sulphide or silicon.

3. The shield according to claim 2, characterized in that the window (1) is made of silicon monocrystal, preferably of a thickness of 50 μm-5 mm.

4. The shield according to any one of the preceding claims, characterized in that the fixing means is at least one fixing opening in the window (1).

5. The shield according to any one of the preceding claims, characterized in that the fixing means is a frame (2).

6. The shield according to claim 5 characterized in that the frame (2) has a shape of a circle, square, rectangle, polygon, triangle or a trapezoid.

7. The shield according to claim 5 characterized in that the frame (2) is made of aluminium, Teflon-coated aluminium, steel, stainless steel, metals and non-ferrous alloys or thermally stable polymers.

8. The shield according to claim 5 characterized in that the frame (2) has at least one opening configured for insertion of immobilizing elements.

9. The shield according to any one of claims 5-8 characterized in that the frame (2) comprises at least one snap fastener.

10. The shield according to claim 5 characterized in that the window (1) is secured to the frame (2) by means of screws, snap fasteners, screws, magnets, riveting, spot welding, spot soldering or heat resistant adhesive.

11. A centrifuge comprising a seat for accommodating an element for centrifugation and infrared radiators (3) characterized in that between the infrared radiator (3) and the element for centrifugation a window (1) or a shield as defined in claim 1 is arranged.

12. The centrifuge according to claim 11 characterized in that the distance of the shield to the infrared radiator (3) is 10 mm-200 mm.

13. The centrifuge according to claim 11 characterized in that the shield is secured to the inner surface of the centrifuge.

14. The centrifuge according to claim 13, characterized in that the inner surface of the centrifuge comprises means for securing a shield, preferably in a form of a snap fastener, snap fastener seat, openings, threaded openings or magnets.

15. The centrifuge according to claim 14 characterized in that the shield is screwed to the inner surface of the centrifuge, preferably the mounting screw extends through an opening (4) in the frame (2) and it is screwed to the wall of the chamber of the centrifuge.
